(19) United States
(12) Patent Application Publication
(10) Pub. No.: US 2014/0362876 A1
(43) Pub. Date: Dec. 11, 2014

(54) METHOD AND SYSTEM FOR MANAGING HEAT DISIPATION IN DOPED FIBER

(71) Applicant: Prima Electro North America, LLC, Chicopee, MA (US)

(72) Inventors: Pieter Schwarzenbach, Longmeadow, MA (US); Matthew J. Silva Sa, Worcester, MA (US); Peter Reeves-Hall, Northbridge, MA (US)

(21) Appl. No.: 13/911,162

(22) Filed: Jun. 6, 2013

(51) Int. Cl. H01S 3/067

(52) U.S. Cl. CPC H01S 3/06733
USPC 372/6

(57) ABSTRACT

An improved fiber array arrangement is provided that incorporates spacing and/or spacers between active fibers in a winding to reduce maximum active fiber temperature, with the spacing/spacer material distributed to minimize heating at locations of high pump power. Spacer material such as “dark” fibers and/or metal wires of similar diameter as the active fiber may be employed to aid winding/bundling of active fibers. Further, the use of channels, grooves, wall material and combinations thereof aid structural support/guidance for the winding/bundling of active fibers while providing predefined spacing and heat conductivity that reduces the maximum thermal temperature of the active fiber below design thresholds.

### BACKGROUND OF THE INVENTION

The present invention relates generally to the management of heat dissipation, overall heat distribution and local thermal increases of active fibers being pumped by a light source. More specifically, the present invention relates to methods and systems for managing the heat dissipation from pumped fiber lasers and or fiber amplifiers in an arrangement that allows higher pumping powers while reducing cladding failure.

Advances in laser technology have allowed for the development of increasingly high powered systems. Such high powered systems include free space lasers, as well as lasers confined to waveguides, such as fiber lasers and fiber laser amplifiers. Fiber lasers have significant advantages over traditional lasers, including stability of alignment, scalability and high optical power of a nearly diffraction limited output beam.

In a fiber laser, the optical fiber typically consist of three regions, a central core glass, a surround cladding glass and a 2^{nd} cladding or “coating” (typically polymer or low index glass). The gain medium of fiber lasers is a length of an optical fiber, the core of which is doped with an active lasing material, typically ions of a rare earth element, such as such as Ytterbium, Erbium, Thulium, Praseodymium etc. The active elements are introduced during the optical fiber manufacturing process and are located in and immediately around the core glass region.

This active region material is usually pumped using an emission of a diode laser or an array of diode lasers. It is typical for high power lasers and amplifiers that the pump light (e.g. 900-1000 nm) that supplies the energy for the laser conversion process is injected into the cladding glass either at one or both ends and/or via a side coupler at one or more locations along the active fiber length. For lower power laser and amplifier requirements the pump light is often coupled directly into the active fiber core at one or both ends. Once the gain medium is excited the core region activates and guides the laser light (at e.g. 1050 nm-1110 nm for ytterbium, 1530-1620 nm for Erbium).

Regardless of pumping technique it is normal to have significant optical power levels in the core and/or in the core and cladding glass. Further, it is normal to find light at both the pump and the laser/amplifier gain wavelengths in both the core and cladding glass regions. As a result, this light energy within the fiber can result in significant heating along the active fiber. Heating can result because the laser process conversion efficiency is always less than 100% with most of the unconverted energy released as thermal energy. Further, the glass type(s) used in the active fiber typically have transmission loss (absorption and re-emission) that also converts energy having wavelengths of greater than 2000 nm into heat. Still further, light that is scattered in the fiber and light at high angles is no longer guided by the cladding and/or coating refractive indexes, leaving it to be absorbed by the coating material and/or potting compounds/adhesives/surround mounting material. This energy is also converted to heat.

Despite the significant heating, it is not usually feasible to package a fiber laser or amplifier such that the active fiber has none or few neighboring active fiber winds.

For example, the active fiber simply cannot be arranged in a straight line of a single circuit of an oval or rounded rectangle as these arrangements would take up too much space. As a result, due to space saving considerations, the fiber is usually wound into a coil (drum, circular, oval, rounded rectangle etc.) in a “spiral” formation. In this arrangement, neighboring active fibers where active fibers packed side by side in a winding/bundle/package results in increases in the per fiber heating increases as all of the neighboring fibers cumulatively increase the thermal load per unit area of the cooling plate/holder.

There is therefore a need for a method and system to manage heat dissipation in an active fiber array such as a pumped fiber laser or fiber amplifier. There is a further need for a method and system to effectively manage and dissipate heat within an active fiber array to allow high power fiber pumping while reducing the risk of damaging or destroying the active fiber.

### BRIEF SUMMARY OF THE INVENTION

In this regard, the present invention provides devices and methods to manage the heat dissipation and local thermal increases of an active, doped optical fiber that is being optically pumped by a light source. The present invention may be implemented using a CW, a pulsed fiber light source, fiber laser or a fiber amplifier for the purpose of removing or redistributing heat from the doped/active optical fiber allowing it to operate at a lower temperature.

The present invention creates arrangements of one or more active fibers that have less thermal noise, generate less heating of the (non-glass) material coating to reduce failure and/or allow higher pumping powers and produce less heating of the (glass) material core and cladding(s) to reduce failure and/or allow higher pumping powers. Further, the present invention produces less heating of potting/gluing compounds that secure the optical fiber in a manner that reduces the thermal failure rate and allows higher pumping powers for the same design thermal limits. Further, by reducing localization of hot spots/zones the cost and complexity of specific material/substrate thermal management solutions is greatly reduced.

In one embodiment, the active fiber is spaced from adjacent fibers within the winding to reduce maximum fiber temperature.

In one embodiment, spacers such as dark fibers or thermally conductive spacers are introduced to allow the escape of heat in a manner that reduces the maximum temperature of the active array.

In another embodiment, the windings are broken into packaged arrays with inter group gaps.

In still a further embodiment a winding plate is employed to provide predefined spacing between packaged arrays to reduce the overall temperature and facilitate heat dissipation.

In still a further embodiment, the active fiber is wound in a manner that the active fiber is adjacent the output fiber further eliminating fiber crossover.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a cross-sectional representation of an optical fiber;

FIG. 2 is a plan view of a fiber array in a conventional coil;

FIG. 3 is a plan view of a fiber array in a conventional coil depicting the heating effects of pumping the active fiber;

FIG. 4 is a plan view of an improved fiber array in accordance with one embodiment of the invention;

FIG. 5 is a plan view of an improved fiber array in accordance with another embodiment of the invention;

FIG. 6 is a plan view of an improved fiber array in accordance with still another embodiment of the invention;

FIG. 7 is a plan view of an improved fiber array in accordance with another embodiment of the invention;

FIG. 8 is a plan view of an improved fiber array in accordance with an embodiment of the invention employing spacers between coil groupings;

FIG. 9 is a plan view of an improved fiber array in accordance with an alternate embodiment of the invention employing spacers between coil groupings; and

FIG. 10 is a plan view of an improved fiber array in accordance with an alternate embodiment of the invention employing a fiber loop formed into a nested coil.

### DETAILED DESCRIPTION OF THE INVENTION

Now referring to the drawings, the system for managing the heat dissipation and local thermal increases of an active, doped optical fiber that is being pumped by light source is shown and generally illustrated. The present invention may be implemented using a CW, a pulsed fiber light source, fiber laser or a fiber amplifier for the purpose of removing or redistributing heat from the doped/active optical fiber allowing it to operate at a lower temperature.

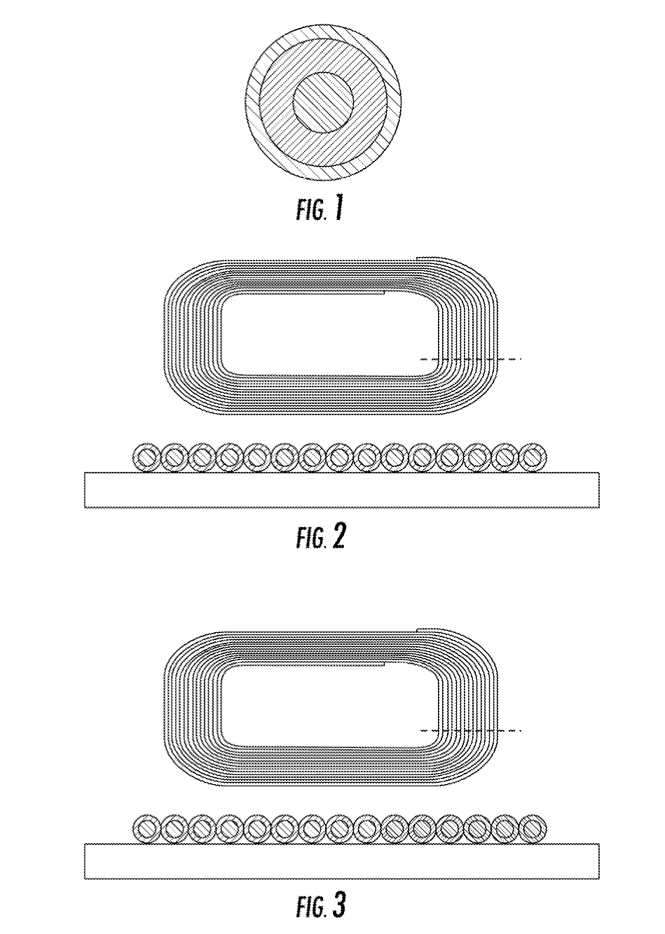

In a fiber laser, the optical fiber, as shown in FIG. 1, typically consists of three regions, a central core glass, a surround cladding glass and a 2^{nd} cladding or “coating” (typically polymer or low index glass). The gain medium of fiber lasers is a length of an optical fiber, the core of which is doped with an active lasing material, typically ions of a rare earth element, such as Ytterbium, Erbium, Thulium, Praseodymium etc. The active elements are introduced during the optical fiber manufacturing process and are located in and immediately around the core glass region thereby forming an active region in the length of the fiber.

To produce laser output, this active region material is usually pumped using an emission of a diode laser or an array of diode lasers. It is typical for high power lasers and amplifiers that the pump light (e.g. 900-1000 nm) that supplies the energy for the laser conversion process is injected into the cladding glass either at one or both ends and/or via a side coupler at one or more locations along the active fiber length. For lower power laser and amplifier requirements the pump light is often coupled directly into the active fiber core at one or both ends. Once the gain medium is excited the core region activates and guides the laser light (at e.g. 1050 nm-1110 nm for ytterbium, 1530-1620 nm for Erbium).

In high power fiber optic systems, such as may include fiber amplifiers, fiber lasers, and fiber coupled diode lasers, a significant amount of heating is generated within the active fiber. Heating can result because the laser process conversion efficiency is always less than 100% with most of the unconverted energy released as thermal energy. Further, the glass type(s) used in the active fiber typically have transmission loss (absorption and re-emission) that also converts energy having wavelengths of greater than 2000 nm into heat. Still further, light that is scattered in the fiber and light at high angles is no longer guided by the cladding and/or coating refractive indexes, leaving it to be absorbed by the coating material and/or potting compounds/adhesives/surround mounting material. This energy is also converted to heat.

Despite the significant heating, it is not usually feasible to package a fiber laser or amplifier such that the active fiber has none or few neighboring active fiber winds. For example, the active fiber simply cannot be arranged in a straight line of a single circuit of an oval or rounded rectangle as these arrangements would take up too much space. As a result, due to space saving considerations, the fiber is usually wound as shown at FIG. 2 into a coil. Further arrangements may include drum, circular, oval, rounded rectangle etc. in a “spiral” formation. In this arrangement, when the pump light is introduced, as shown in FIG. 3, neighboring active fibers where active fibers packed side by side in a winding/bundle/package results in increased fiber heating as all of the neighboring fibers cumulatively increase the thermal load per unit area of the cooling plate/holder.

It should be noted that as used herein, the term “high power” refers to at least one or more hundred watts and for many applications may mean one or more kilowatts. By way of example, lasers with high output powers are required for a number of applications, e.g., for material processing (welding, cutting, drilling, marking, surface modification), large-scale laser displays, military applications, particle acceleration, and laser-induced nuclear fusion. It will be understood that the present invention is not limited to lasers as it may be applied to other high power optical applications, such as fiber amplifiers and fiber coupled laser diodes.

The various embodiments of the present invention are directed at managing the heat within each of the adjacent active fibers to reduce the maximum temperature thereof. Accordingly, the embodiments describe devices that incorporate spacing and/or spacers between active fibers in a winding to reduce maximum active fiber temperature, with the spacing/spacer material distributed to minimize heating at locations of high pump power. Spacer material (such as “dark” fibers and/or metal wires of similar diameter as the active fiber) may be employed to aid winding/bundling of active fibers with structural support/guidance while providing predefined spacing and the use of heat conductive spacers that reduce the maximum thermal temperature of the active fiber below design thresholds. Further, the use of channels, grooves, wall material and combinations thereof aid structural support/guidance for the winding/bundling of active fibers while providing predefined spacing and heat conductivity that reduces the maximum thermal temperature of the active fiber below design thresholds.

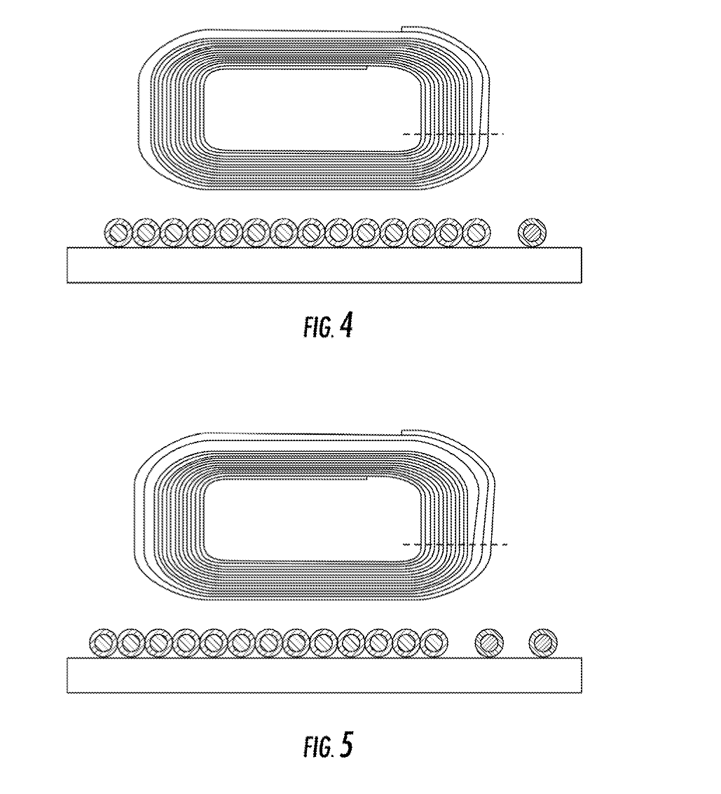

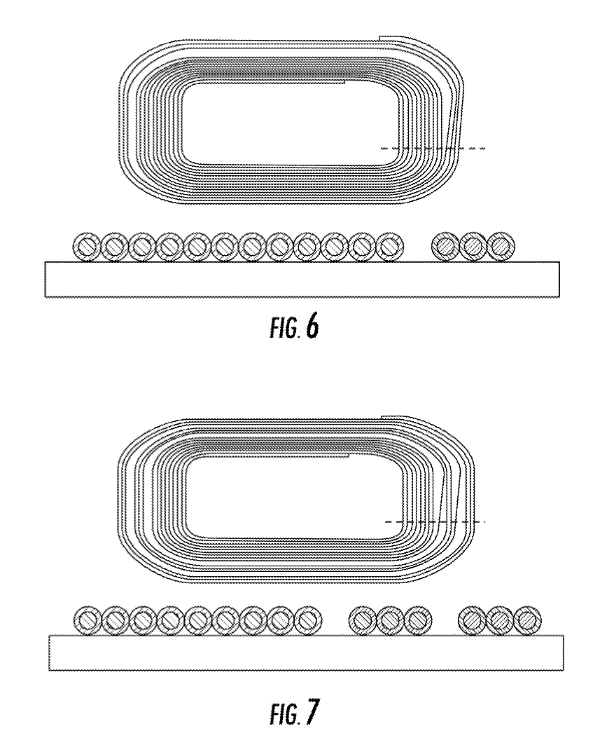

As can be seen at FIG. 4, the present invention provides for introducing one or more gaps between adjacent windings at the hottest fiber loop. As can be seen, the fiber array is formed from a continuous strand of optical fiber having an active fiber portion at an input, pumped end thereof and an output end opposite the input end. The optical fiber being arranged in a wound array wherein each of a coil in the wound array lies adjacent a previous coil, further wherein each coil of said wound array comprising said active fiber portion is spaced apart from adjacent coils of active fiber. In this manner the loop with the greatest input pump power intensity is spaced apart from the array until packed bundling can resume keeping maximum fiber temperature below a design target while minimizing area/size of the array. Further, FIG. 5 depicts an arrangement wherein several adjacent windings are spaced apart from the coil. Here the fiber comprises more than one winding grouped adjacent one another, said group being in spaced apart relation to the wound array. Similarly, the active portion of the fiber includes a plurality of windings grouped into one or more groups, each coil with a group adjacent one another, each of said groups being in spaced apart relation to the wound array.

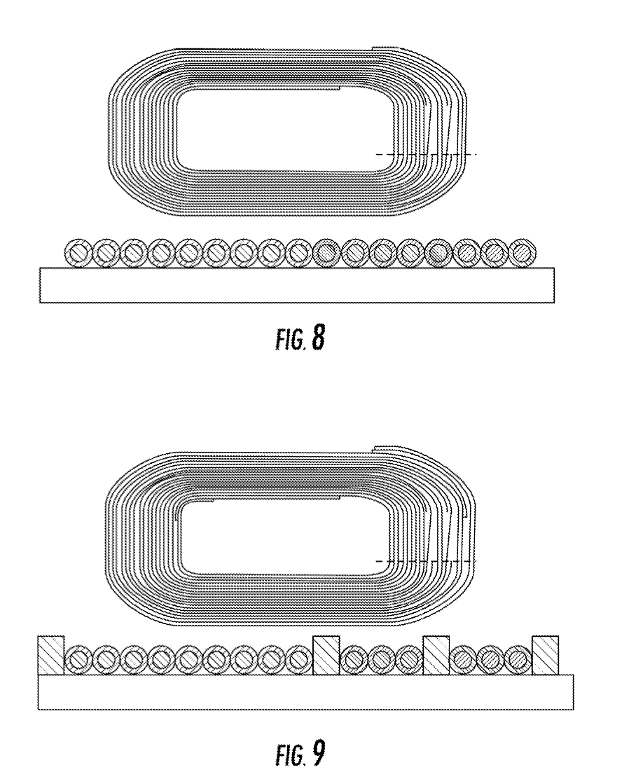

FIGS. 6 and 7 depict one or more Small packed groups of hottest fibers with inter group gap(s) until packed bundling can resume keeping maximum fiber temperature below a design target. In this arrangement the groups may be separated to isolate the hottest fiber windings from other fibers or into groups where the hottest fiber windings are on the outside, a group of moderately heated fibers are then bundled and finally normal winding spacing is resumed.

To assist in manufacture and winding of the fiber array, one embodiment of the present invention as shown at FIG. 8 provides for the introduction of spacers between separated fibers or groups of fibers. In this regard spacers may be formed using “dark” (unused/un-illuminated) fibers and/or metal wires (e.g. solid core copper wire) of a diameter that is of a similar diameter to the active fiber. The spacers implemented in this manner provide structural support and guidance while winding and securing active fiber bundles. This arrangement provides spacing of the active fiber with the advantage of reducing the maximum temperature of the active fiber below thermal design targets. Further should metal wires be employed this arrangement provides side-ways thermal dissipation of active fibers.

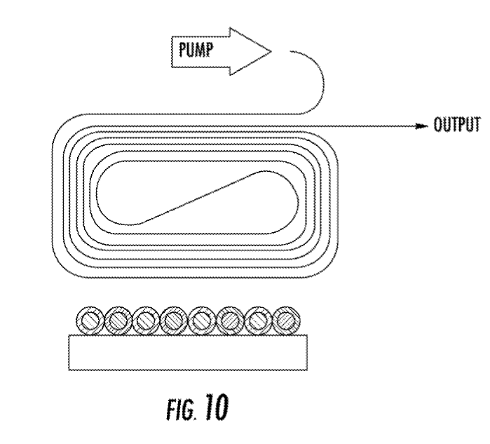

At FIG. 9 a similar embodiment is provided wherein channels or walls are utilized. The use of channels, grooves or wall materials such as machined aluminum plate, aids in providing structural support/guidance for the winding/bundling of active fibers while providing predefined spacing's/heat conductive spacers that reduce the maximum thermal temperature of the active fiber below design thresholds and providing side-ways thermal dissipation of active fibers.

Still further, FIG. 10 provides an embodiment wherein the continuous strand of active fiber is formed into a looped coil. In this arrangement the fibers is formed into a loop that is then wound into a coil such that the input portion and output portion of the fiber are wound to lie in alternating adjacent relationship with one another. In this arrangement each hot active fiber segment lies next and is separated by a cool downstream output fiber segment. This looped coil arrangement also facilitates a package wherein there is no need for crossing a fiber over the active fiber raceway.

It should be appreciated by one skilled in the art that such arrays are arranged in any known configuration including but not limited to on a support, a backer plate, directly on a cold plate or between combinations of these. Further the array is preferably adhered or potted to the backer plate. Still further it is preferred that the backer plate and adhesive/potting be part of an overall comprehensive thermal management solution wherein the adhesive/potting and backer plate are thermally conductive materials or heat sinks in their own right.

It can therefore be seen that the present invention provides an improved fiber array arrangement that incorporate spacing and/or spacers between active fibers in a winding to reduce maximum active fiber temperature, with the spacing/spacer material distributed to minimize heating at locations of high pump power. Spacer material (such as “dark” fibers and/or metal wires of similar diameter as the active fiber) may be employed to aid winding/bundling of active fibers with structural support/guidance while providing predefined spacing and the use of heat conductive spacers that reduce the maximum thermal temperature of the active fiber below design thresholds. Further, the use of channels, grooves, wall material and combinations thereof aid structural support/guidance for the winding/bundling of active fibers while providing predefined spacing and heat conductivity that reduces the maximum thermal temperature of the active fiber below design thresholds. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A fiber array comprising:
at least one continuous strand of optical fiber having an active fiber portion at a first end thereof and a second end opposite said first end;
said optical fiber being arranged in a wound array wherein each of a coil in the wound array lies adjacent a previous coil, wherein each coil of said wound array comprising said active fiber portion is spaced apart from adjacent coils of active fiber.

2. The fiber array of claim 1, wherein said active portion of said fiber comprises a single wound coil in spaced apart relation to the wound array.

3. The fiber array of claim 1, wherein said active portion of said fiber comprises more than one wound coil in spaced apart relation to the wound array.

4. The fiber array of claim 1, wherein said active portion of said fiber comprises more than one wound coil grouped adjacent one another, said group being in spaced apart relation to the wound array.

5. The fiber array of claim 1, wherein said active portion of said fiber comprises a plurality of wound coils grouped into one or more groups, each coil with a group adjacent one another, each of said groups being in spaced apart relation to the wound array.

6. The fiber array of claim 1, wherein said array is arranged on a backer plate or a cold plate.

7. The fiber array of claim 6, wherein said fiber array is affixed to said backer plate or cold plate.

8. A fiber array comprising:
at least one continuous strand of optical fiber having an active fiber portion at a first end thereof and a second end opposite said first end;
said optical fiber being arranged in a wound array wherein each of a coil in the wound array lies adjacent a previous coil, wherein each coil of said wound array comprising said active fiber portion is spaced apart from adjacent coils of active fiber; and
a spacer positioned between said spaced adjacent coils of active fiber.

9. The fiber array of claim 8, wherein said active portion of said fiber comprises a single wound coil in spaced apart relation to the wound array, a spacer positioned between said single wound coil and said wound array.

10. The fiber array of claim 8, wherein said active portion of said fiber comprises more than one wound coil in spaced apart relation to the wound array, a spacer positioned between each of said wound coils and said wound array.

11. The fiber array of claim 8, wherein said active portion of said fiber comprises more than one wound coil grouped adjacent one another, said group being in spaced apart relation to the wound array, a spacer positioned between said group of wound coils and said wound array.

12. The fiber array of claim 8, wherein said active portion of said fiber comprises a plurality of wound coils grouped into one or more groups, each coil with a group adjacent one another, each of said groups being in spaced apart relation to the wound array, a spacer positioned between each of said groups of wound coils and said wound array.

14. The fiber array of claim 8, wherein said spacer is selected from the group consisting of: dark fiber, metal wire, channels, grooves and walls.

15. The fiber array of claim 8, wherein said array is arranged on a backer plate or a cold plate.

16. The fiber array of claim 15, wherein said fiber array is affixed to said backer plate or cold plate.

17. A fiber array comprising:
at least one continuous strand of optical fiber having an active fiber portion at a first end thereof and a second end opposite said first end, said optical fiber being looped back onto itself, said loop being arranged in a looped wound array,
wherein each of an active coil in the wound array lies adjacent an output coil of the wound array.

18. The fiber array of claim 17, wherein said array is arranged on a backer plate or cold plate.

19. The fiber array of claim 18, wherein said fiber array is affixed to said backer plate or cold plate.
